(19) United States
(12) Patent Application Publication
(10) Pub. No.: US 2023/0137765 A1
(43) Pub. Date: May 4, 2023

(54) ROTOR OF AN ELECTRIC ROTATING MACHINE, AND ELECTRIC ROTATING MACHINE

(71) Applicant: Schaeffler Technologies AG & Co. KG, Herzogenaurach (DE)

(72) Inventors: Alexandre Fischer, Strasbourg (FR); Florian Nachtmann, La Wantzenau (FR); Sebastien Heitz, Niederschaeffolsheim (FR)

(73) Assignee: Schaeffler Technologies AG & Co. KG, Herzogenaurach (DE)

(21) Appl. No.: 17/918,569

(22) PCT Filed: Mar. 16, 2021
(86) PCT No.: PCT/DE2021/100257

§ 371 Date: Oct. 13, 2022

(30) Foreign Application Priority Data
Apr. 14, 2020 (DE) 10 2020 110 168.6

(51) Int. Cl. H02K 1/32; H02K 1/276; H02K 9/197

(52) U.S. Cl. CPC H02K 1/32; H02K 1/276; H02K 9/197

(57) ABSTRACT

A rotor has an iron core with rotor laminations which are arranged in at least one stack, plane-parallel to one another. At least one of the rotor laminations is designed as a fluid-conducting lamination and forms at least one flow channel having at least one radial direction component, which flow channel is open on at least one axial side of the fluid-conducting lamination. A rotor lamination is designed as a sealing lamination being arranged on the axially open side of the fluid-conducting lamination, by means of which rotor lamination designed as a sealing lamination the flow channel of the fluid-conducting lamination is sealed substantially fluid-tight on the side of the sealing lamination.

### CROSS-REFERENCE TO RELATED APPLICATIONS

This application is the U.S. National Phase of PCT Appln. No. PCT/DE2021/100257 filed Mar. 16, 2021, which claims priority to DE 10 2020 110 168.6 filed Apr. 14, 2020, the entire disclosures of which are incorporated by reference herein.

### TECHNICAL FIELD

The disclosure relates to a rotor of an electric rotating machine and the electric rotating machine with the rotor.

### BACKGROUND

Permanent magnet synchronous machines are used in many industrial applications and increasingly also in the automotive industry. Such a permanent magnet synchronous machine comprises a stator to be energized and a permanent magnet rotor. The rotor usually comprises a shaft, balancing plates, rotor laminated cores, and magnets. The magnets are generally fixed in the rotor laminated cores.

The performance of an electric rotating machine depends, among other things, on the heat generated during operation, since the efficiency of the machine decreases with increasing heat.

It is also known that what are termed hot spots can occur in an electric rotating machine. A hot spot is a region of greatest heat generation in the rotor and/or stator during operation of the electric machine.

Measures that are generally used to cool a rotor and stator of an electric machine are cooling the rotor from radially inside by means of a coolant using centrifugal force, wherein the coolant flows along the end faces of the rotor here, and cooling the stator from radially outside by means of a coolant as well as a dissipation of the coolant and thus also of the heat absorbed by the coolant.

However, such cooling might not be sufficient to cool the most heated regions, depending on the particular design conditions. In the event of insufficient cooling, power losses occur in the electric machine concerned.

To compensate for this power loss and to achieve a required performance of the electric machine, more powerful magnets are usually used, although these have the disadvantage of being more expensive and requiring more installation space.

Mass-produced permanent magnet synchronous machines are often cooled via cross-bores located radially inside the rotor which are fluidically connected to cooling ducts on the axial side surfaces of the rotor. With this concept, the heat of the rotor is mainly dissipated via the side surfaces. Accordingly, the magnets in the axial center of the rotor heat up the most in this concept, since they are furthest away from the heat sinks, and this is where the highest power losses occur due to the heat.

To counteract the formation of hot spots in the axial center of the rotor, the concept of magnet cooling with a separate oil-conducting lamination was developed. Oil is conducted radially from the shaft into transverse channels in the rotor stack via an oil-conducting lamination arranged between two rotor stacks. This oil-conducting lamination is made of aluminum or another non-magnetic material to minimize or completely avoid magnetic leakage flux.

Rotor cooling with a separate conventional oil-conducting lamination has the following disadvantages:
Increased axial space requirements of the electric machine,
Loss of active length of the rotor while maintaining the geometric dimensions,
Increased installation effort and complex handling of the usually relatively thin oil-conducting lamination,
Costs due to logistics for an additional part,
Costs due to additional tools for the production of the oil-conducting lamination,
Different heat-related expansion behavior of the lamination stack due to different materials used,
Positioning of the oil-conducting lamination is only possible between individual lamination stacks or stacks, so that an axially central arrangement of an oil-conducting lamination is only possible with an even number of stacks.

### SUMMARY

Proceeding from this, the object of the present disclosure is to provide a rotor of an electric rotating machine and the electric rotating machine equipped therewith which, with optimal cooling of integrated magnets, exhibit essentially no loss in terms of the axial active length even in the axial central region.

This object is achieved by a rotor and by an electric rotating machine according to the present disclosure.

Advantageous embodiments of the rotor are described herein.

The features of the claims can be combined in any technically meaningful way, with the explanations from the following description and features from the figures also possibly being used for this purpose, which include supplementary designs of the disclosure.

In the context of the present disclosure, the terms “radial” and “axial” always refer to the axis of rotation of the rotor.

The disclosure relates to a rotor of an electric rotating machine, comprising an iron core with rotor laminations which are arranged in at least one stack, plane-parallel to one another, at least one of the rotor laminations being designed as a fluid-conducting lamination and forming at least one flow channel having at least one radial direction component, which flow channel is open on at least one axial side of the fluid-conducting lamination. A rotor lamination designed as a sealing lamination is arranged on the axially open side of the fluid-conducting lamination, by means of which the flow channel of the fluid-conducting lamination is sealed substantially fluid-tight on the side of the sealing lamination.

The rotor laminations are a substantial part of the iron core of the electric machine concerned, wherein these laminations can be in the form of laminated and insulated laminations. In particular, the rotor laminations are designed on the radial outer regions thereof with pockets or receptacles for receiving magnets.

The design of the rotor according to the disclosure makes it possible to conduct cooling fluid radially to axially central positions of the rotor within the stack arrangement, also referred to as a stack, without needing to accept significant losses in terms of the magnetic properties at the position of this radial oil guide.

In particular, the fluid-conducting lamination can consist essentially of the same material as the other rotor laminations of the iron core. Correspondingly, it is provided that the additional rotor laminations and the fluid-conducting lamination essentially have the same magnetic properties or the same properties with regard to their magnetizability.

Furthermore, the sealing lamination can also consist essentially of the same material as the other rotor laminations of the iron core. Accordingly, it is provided that the further rotor laminations and the sealing lamination essentially have the same magnetic properties or the same properties with regard to their magnetizability.

In particular, the flow channel of the fluid-conducting lamination can be designed to be open axially on both sides. In this case, a rotor lamination designed as a sealing lamination is arranged axially on both sides of the fluid-conducting lamination, by means of which the flow channel of the fluid-conducting lamination is sealed substantially fluid-tight on the side of the sealing lamination concerned. This embodiment ensures that a relatively large cooling fluid volume flow can be conducted in the radial direction with minimal axial space requirements.

In a stack arrangement, multiple fluid-conducting laminations can be arranged directly adjacent to one another in a group of fluid-conducting laminations, so that they form a common flow channel, wherein a sealing lamination is, in each case, arranged axially on both sides of this group of fluid-conducting laminations for the axial sealing of the common flow channel. In this embodiment, the flow channels in the fluid-conducting laminations are designed to be open on both sides, so that they are fluidically connected to one another in the adjacent arrangement of the fluid-conducting laminations. This embodiment ensures that at the axial position of the side-by-side arrangement, a large cooling fluid volume flow can be conducted radially outwards and, correspondingly, a higher cooling capacity can be realized.

The fluid-conducting lamination or the group of fluid-conducting laminations can be arranged in a stack arrangement, so that further rotor laminations of the stack arrangement are arranged on both sides of the fluid-conducting lamination or the associated sealing laminations.

In an alternative embodiment, a sealing lamination axially closes off the stack arrangement concerned in which the fluid-conducting lamination is arranged. This means that the associated fluid-conducting lamination is also arranged at an axial end position of the stack arrangement. This embodiment can be implemented in particular when two stack arrangements adjoin one another in an axially central region of the iron core.

The fluid-conducting lamination can have a recess in the central region thereof for receiving a rotor shaft, wherein the flow channel opens on the radially inner side of the fluid-conducting lamination. This means that the fluid-conducting lamination has at least one interruption or opening on the radially inner side through which cooling fluid can flow from a wave guide in the radial direction into the flow channel of the fluid-conducting lamination, from which it can be conducted further outwards in the radial direction in the direction of the magnets of the rotor.

This fluid flow is supported by the centrifugal force occurring during operation of the electric rotating machine. In particular, there can be multiple such openings or junctions distributed on the circumference of the fluid-conducting lamination on the radial inner side, which lead to multiple flow channels.

The sealing lamination can also have a recess in the central region thereof for receiving a rotor shaft, wherein the contour of the recess of the sealing lamination is designed to form a torque transmission acting in a form-fitting manner to a shaft that passes or is to be passed through the recess. In particular, the contour of the recess can be designed with a lug running radially inwards for engagement in a groove in the shaft, which is designed to be complementary in terms of shape and size.

Likewise, the other rotor laminations of the stack arrangement or the iron core can be designed at the respective recess thereof designed for the passage of the rotor shaft with a contour corresponding to the sealing lamination or with a lug running radially inwards for engagement in a groove in the shaft, which is designed to be complementary in terms of shape and size.

A respective fluid-conducting lamination can also have this contour, which, however, can be interrupted by the junction of a respective flow channel. In this case, the contour only serves to carry along the fluid-conducting lamination in the rotary movement of the shaft or the additional rotor laminations.

A respective flow channel in the fluid-conducting lamination can lead to an axial outlet from which the fluid conducted with the flow channel can be output axially out of the fluid-conducting lamination. In the design that is open axially on both sides, the flow channel correspondingly leads to a window, which in particular delimits the flow channel in the radial direction, so that the fluid is forced at this radial position to exit axially from the fluid-conducting lamination.

In particular, the flow channel can form at least one branch in this regard, so that it has multiple sub-channels that run radially with at least one directional component.

The flow channel can initially extend in the radial direction starting from a junction at the radially inner contour and form a branch and thus two sub-channels essentially in the central radial region of the fluid-conducting lamination. The two sub-channels can extend at an angle to the radial direction from the branch in the direction of the radial outer side of the fluid-conducting lamination, where they each lead to an axial outlet. Such a flow channel essentially forms a Y-shape.

The rotor can be designed in such a way that the rotor laminations of a stack arrangement form at least one axial flow channel which in the direction of longitudinal extent thereof runs essentially parallel to the axis of rotation of the rotor and is fluidically connected to a respective flow channel of a respective fluid-conducting lamination. In particular, it is provided that the axial outlets in the fluid-conducting lamination are components of the axial flow channel.

In an advantageous embodiment, the sealing laminations and other rotor laminations also have axial through-openings or windows in the same radial positions and the same circumferential positions as the axial outlets of the fluid-conducting lamination, so that these windows in the sealing laminations or other rotor laminations are also components of the axial flow channel.

Cooling fluid can be conducted very closely to the radial outer side of the rotor through this axial flow channel, which is located far radially on the outside, and the heat generated during operation of the electric rotating machine can be efficiently absorbed and dissipated via convection.

In this case, however, the active length of the rotor is not restricted, since both a respective fluid-conducting lamination and a respective sealing lamination act actively as a rotor lamination.

Another aspect of the present disclosure is an electric rotating machine, which comprises a rotor according to the present disclosure.

### BRIEF DESCRIPTION OF THE DRAWINGS

The disclosure described above is explained in detail below against the concerned technical background with reference to the accompanying drawings, which show preferred embodiments. The disclosure is in no way limited by the purely schematic drawings, wherein it is noted that the exemplary embodiments shown in the drawings are not limited to the dimensions shown. In the figures:

FIG. 1: shows a rotor according to the disclosure in a side view (upper partial representation) and in a sectional view (lower partial representation),

FIG. 2: shows a rotor lamination of the rotor,

FIG. 3: shows a fluid-conducting lamination of the rotor,

FIG. 4: shows a sealing lamination of the rotor, and

FIG. 5: shows a detail from a sectional view of the rotor according to the disclosure.

### DETAILED DESCRIPTION

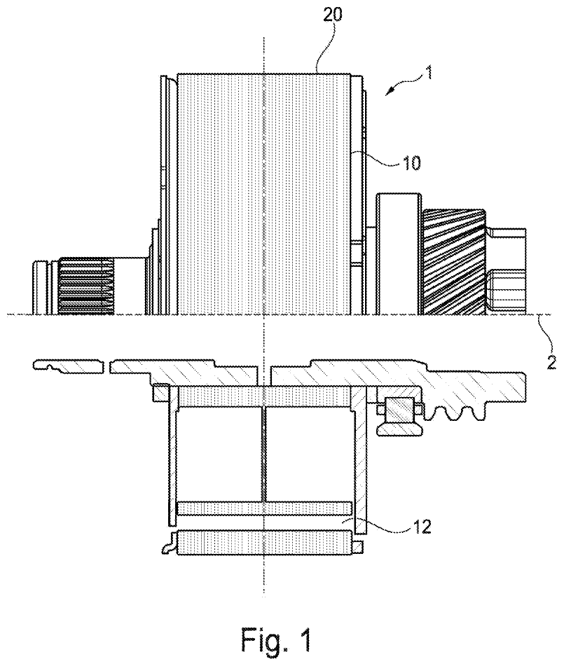

As can be seen from FIG. 1, the rotor 1 comprises multiple rotor laminations 20 which are arranged to be parallel to one another and which are arranged in a stack arrangement 10 on a common axis of rotation 2.

The view shown below the axis of rotation 2 shows that the rotor laminations 20 together form an axial flow channel 12. Within the stack arrangement 10, which can also be referred to as a stack, conventional rotor laminations 20 are arranged, as well as at least one fluid-conducting lamination 30, which is axially sealed by a sealing lamination 50.

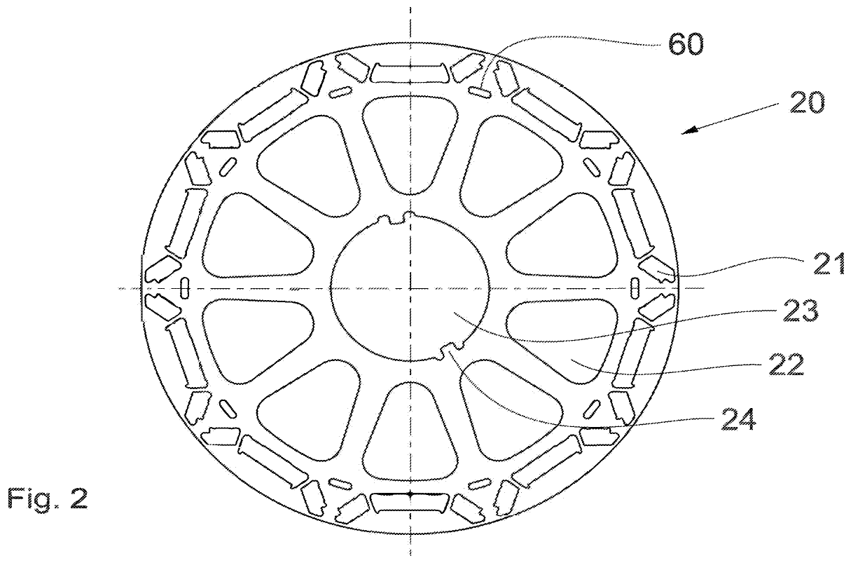

The stack arrangement 10 is essentially or predominantly formed by rotor laminations 20, as illustrated in FIG. 2. In this case, FIG. 2 represents what is termed a further rotor lamination, which forms the predominant part of the laminated core.

These further rotor laminations 20 comprise multiple pockets 21 on the respective radial outer side thereof for the form-fitting arrangement of magnets to form a respective rotor. In the radially central region, a respective rotor lamination 20 has essentially triangular cutouts 22 distributed regularly on the circumference, which serve in particular to reduce mass and thus also to reduce the mass moment of inertia of the laminated core formed therewith. In the radially central region, the rotor lamination 20 has a recess 23 that is essentially circular in this case. Furthermore, the rotor lamination 20 has two radially inwardly extending lugs 24 which are designed to engage in a complementarily designed groove of a rotor shaft, not shown here.

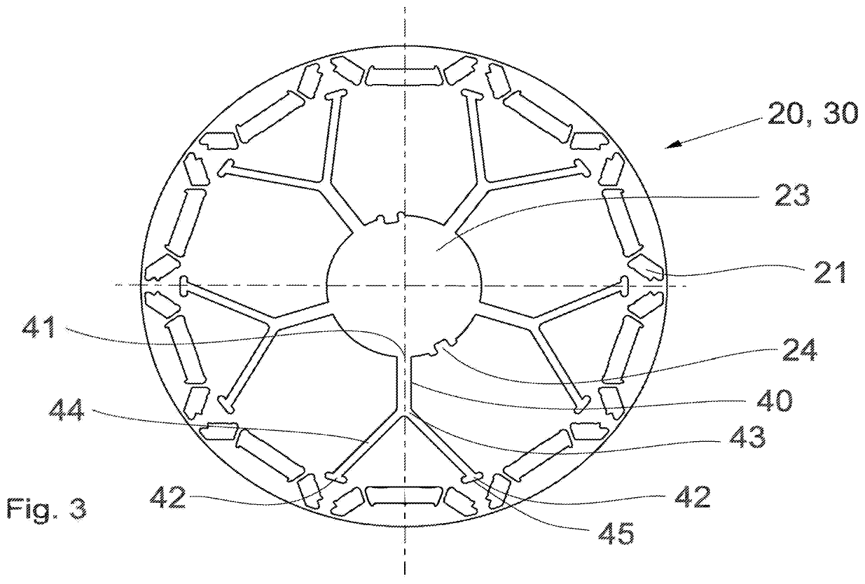

FIG. 3 shows a fluid-conducting lamination 30. This fluid-conducting lamination 30 comprises multiple flow channels 40 which form openings 41 on the radial inner side of the fluid-conducting lamination 30. These serve to introduce cooling fluid which is conducted in a shaft guide of a rotor shaft, not shown here, that is led through the recess 23, into the flow channels 40. A respective flow channel 40 also has branches 43 in the embodiment shown here, so that a first sub-channel 44 and a second sub-channel 45 connect to a section of the concerned flow channel 40 starting from an opening 41 and the flow channel 40 as a whole has essentially a Y-shape. The two sub-channels 44, 45 each end in an axial outlet 42, which is designed here as a window and is positioned radially relatively far outside on the fluid-conducting lamination 30. In the embodiment shown here, these axial outlets 42 are in the immediate vicinity of the pockets 21, which serve to receive the magnets of the rotor. Correspondingly, cooling fluid can be conducted from a central shaft via the openings 41 into the flow channels 40 and from there to the axial outlets 42, wherein the axial outlets 42 are components of the axial flow channel 12 indicated in FIG. 1 or are fluidically connected to this axial flow channel 12.

In the embodiment shown here, a respective flow channel 40 is designed as a recess axially passing through the fluid-conducting lamination 30.

The fluid-conducting lamination 30 is accordingly a specially designed rotor lamination 20 and is preferably made of the same material as the remaining or further rotor laminations 20 of the stack arrangement 10. Accordingly, it is provided that the fluid-conducting lamination 30 is also made from a magnetizable material.

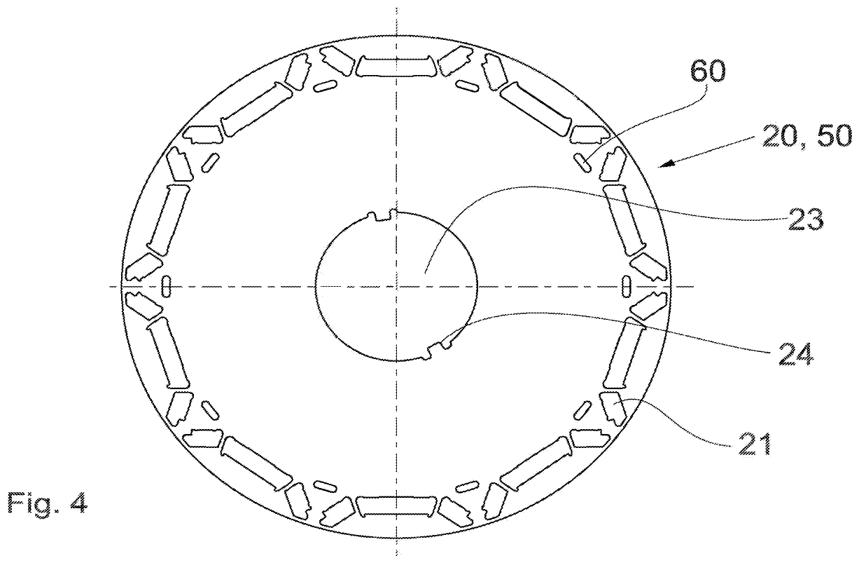

To ensure that cooling fluid in the flow channel 40 is conducted through the sub-channels 44, 45 only in the radial direction or with a radial component, sealing laminations 50 are provided to cover a respective flow channel 40. Such a sealing lamination 50 is shown in FIG. 4. It can be seen that this sealing lamination 50 also has pockets 21 for receiving the magnets of the rotor. It can also be seen that the sealing lamination 50 is closed in the radial regions in which the flow channels 40 are formed in the fluid-conducting lamination 30. This ensures that when the sealing lamination 50 rests on one side of the fluid-conducting lamination 30, the concerned flow channel 40 is closed in a fluid-tight manner on this side in the axial direction, in particular when there is an axially acting contact pressure force from the concerned sealing lamination 50 on the fluid-conducting lamination 30.

The fluid-conducting lamination 30 and also the sealing lamination 50 also have lugs 24 on the radially inner contours thereof, wherein the lugs 24 on the sealing lamination 50 serve to transmit torque to the shaft from the sealing lamination, which also acts as a rotor lamination. The lugs 24 on the fluid-conducting lamination 30 mainly serve to carry along the fluid-conducting lamination 30 in the rotary movement of the shaft.

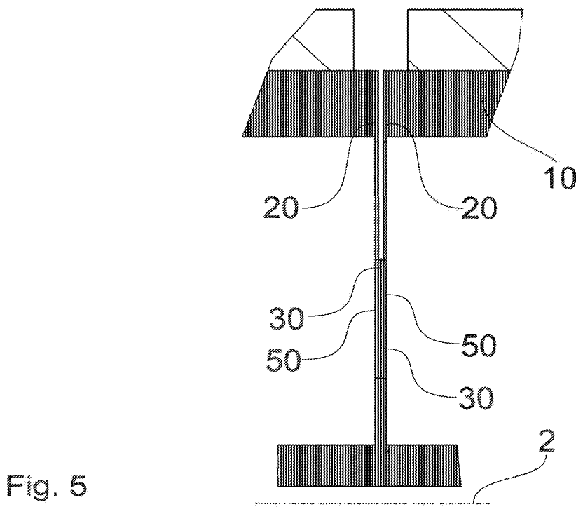

However, the disclosure is not restricted to a sealing lamination 50, in each case, being arranged axially on both sides of a fluid-conducting lamination 30. Deviating therefrom, it can also be provided that—as shown in FIG. 5—multiple fluid-conducting laminations 30 form a group 11 of fluid-conducting laminations 30, wherein the fluid-conducting laminations 30 rest directly against one another here. In this case, only the axial outer sides of this group 11 of fluid-conducting laminations 30 are covered by sealing laminations 50.

Both the rotor lamination 20 and the sealing lamination 50 have windows 60 at the radial positions and angular positions of the axial outlets 42 of the fluid-conducting lamination 30, so that in a direct side-by-side arrangement of all rotor laminations 20, which also include the fluid-conducting lamination 30 and a respective sealing lamination 50, these windows 60 form the axial flow channel 12 together with the axial outlets 42.

A reliable and targeted cooling of the magnets also in an axially central region can be achieved with the rotor proposed here with a very compact axial design on the whole.

### LIST OF REFERENCE SYMBOLS

1 Rotor

2 Axis of rotation

10 Stack arrangement

11 Group of fluid-conducting laminations

12 Axial flow channel

20 Rotor lamination

21 Pocket

22 Cutout

23 Recess

24 Lug

30 Fluid-conducting lamination

40 Flow channel

41 Opening

42 Axial outlet

43 Branch

44 First sub-channel

45 Second sub-channel

50 Sealing lamination

60 Windows of the axial flow channel

1. A rotor of an electric rotating machine, comprising an iron core with rotor laminations which are arranged in at least one stack, plane-parallel to one another, at least one of the rotor laminations being designed as a fluid-conducting lamination and forming at least one flow channel having at least one radial direction component, wherein the at least one flow channel is open on at least one axial side of the fluid-conducting lamination, and at least one of the rotor laminations is designed as a sealing lamination arranged on the axially open side of the fluid-conducting lamination, by means of which the flow channel of the fluid-conducting lamination is sealed substantially fluid-tight on side of the sealing lamination.

2. The rotor according to claim 1, wherein the fluid-conducting lamination is formed of a same material as other rotor laminations of the iron core.

3. The rotor according to claim 1, wherein the sealing lamination is formed of a same material as other rotor laminations of the iron core.

4. The rotor according to claim 1, wherein the flow channel of the fluid-conducting lamination is open axially on both sides and the sealing lamination is, in each case, arranged axially on both sides of the fluid-conducting lamination, by means of which the flow channel of the fluid-conducting lamination is sealed substantially fluid-tight on the side of the sealing lamination.

5. The rotor according to claim 1, wherein a plurality of fluid-conducting laminations are arranged directly adjacent to one another in a stack arrangement in a group of fluid-conducting laminations, so that they form a common flow channel, a sealing lamination being, in each case, arranged axially on both sides of the group of fluid-conducting laminations for axial sealing of the common flow channel.

6. The rotor according to claim 1, wherein the fluid-conducting lamination has a recess in a central region thereof for receiving a rotor shaft, the flow channel opening on a radially inner side of the fluid-conducting lamination.

7. The rotor according to claim 1, wherein the sealing lamination has a recess in a central region thereof for receiving a rotor shaft, a contour of the recess of the sealing lamination being designed to form a torque transmission acting in a form-fitting manner to a shaft that passes through the recess.

8. The rotor according to claim 1, wherein the flow channel in the fluid-conducting lamination leads to an axial outlet from which fluid conducted with the flow channel can be output axially out of the fluid-conducting lamination.

9. The rotor according to claim 1, wherein the rotor laminations form at least one axial flow channel which in a direction of longitudinal extent thereof runs parallel to an axis of rotation of the rotor and is fluidically connected to a respective flow channel of a respective fluid-conducting lamination.

10. An electric rotating machine, comprising:
an iron core having rotor laminations arranged in at least one stack plane, plane-parallel to one another, wherein:
at least one of the rotor laminations is a fluid-conducting lamination that forms at least one flow channel, the at least one flow channel being open on at least one axial side of the fluid-conducting lamination; and
at least one of the rotor laminations is a sealing lamination arranged on the axially open side of the fluid-conducting lamination, the flow channel of the fluid-conducting lamination being sealed substantially fluid-tight on a side of the sealing lamination via the sealing lamination.
